(19) United States
(12) Patent Application Publication
(10) Pub. No.: US 2011/0057456 A1
(43) Pub. Date: Mar. 10, 2011

(54) DRIVES FOR SEALED SYSTEMS

(75) Inventors: Kais Atallah, Sheffield (GB); Jan Jozef Rens, Sheffield (GB)

(73) Assignee: MAGNOMATICS LIMITED, Sheffield, South Yorkshire (UK)

(21) Appl. No.: 12/812,513

(22) PCT Filed: Jan. 12, 2009
(86) PCT No.: PCT/GB2009/000080

§ 371 Date: Sep. 15, 2010

(30) Foreign Application Priority Data
Jan. 11, 2008 (GB) 0800462.4

(51) Int. Cl. H02K 7/11; H02K 49/10

(52) U.S. Cl. 290/1 C; 310/104

(57) ABSTRACT

A drive for a sealed magnetically geared system comprising a housing defining a sealed chamber, a driving member including a first set of magnets, and a driven member comprising a second set of magnets, one of the members being located inside the chamber, wherein the first and second sets of magnets are arranged to produce different numbers of magnetic poles, and the housing includes a wall extending between the members and supporting a plurality of pole pieces which are arranged to modulate the magnetic field acting between the magnets.

### FIELD OF THE INVENTION

The present invention relates to sealed systems such as pumps and turbines, and in particular to drive systems for such systems.

### BACKGROUND TO THE INVENTION

Pumps and turbines are used in a wide variety of applications and are connected to a source of rotational or linear power, such as motors, actuators or complementary pumps or turbines in a number of different ways. In some pumps the source of power operates at a different speed from the driven mechanism. Also, it is often required that the fluid in which the pump or other mechanism is immersed must be prevented from contaminating the rest of the drive system. Therefore, a pump or turbine may comprise a hermetic seal between the source of rotational or linear power and the pump, turbine or other mechanism and some form of gearing between the drive system and the driven mechanism.

### SUMMARY OF INVENTION

The present invention provides a magnetically geared system comprising a housing defining a sealed chamber, a driving member including a first set of magnets, and a driven member comprising a second set of magnets, one of the members being located inside the chamber, wherein the first and second sets of magnets are arranged to produce different numbers of magnetic poles, and the housing includes a wall extending between the members and supporting a plurality of pole pieces which are arranged to modulate the magnetic field acting between the magnets.

The chamber is sealed, for example, the chamber is capable of sealing in a fluid, that is, liquid and gas. Depending on the application it may be hermetically sealed.

The spacing of the magnetic poles in the first set of magnets may be greater than the spacing of the magnetic poles of the second set such that the driven member is driven at a slower speed than the driving member. Alternatively spacing of the magnetic poles of the first set of magnets may be greater than the spacing of the magnetic poles of the second set such that the driven member is driven at a higher speed than the driving member.

The system may be rotary, in which case the members may be rotors. In this case the first set of magnets may include a lower number of magnets, or at least may define a smaller number of magnetic poles, than the second set such that the second rotor is driven at a slower speed than the first rotor. Alternatively the first set of magnets may include a higher number of magnets, or at least a higher number of magnetic poles, than the second set such that the second rotor is driven at a higher speed than the first rotor.

The wall may be tubular in form and the coupling arranged to operate radially, with one of the rotors arranged radially inside the wall and the other of the rotors arranged radially outside the wall. Alternatively the coupling may be arranged to act axially, with the rotors arranged on opposite sides of a flat wall, spaced apart in the axial direction of their common axis of rotation. The coupling may also be arranged to act linearly, in which the wall may be a flat plate and the members in the form of translators which are positioned on either side of the wall. The coupling may also be arranged to act linearly, with the wall being tubular and with one translator arranged radially outside the wall and the other translator arranged radially inside the wall.

The first rotor may be located radially outside the wall and the second rotor arranged radially inside the wall.

The pole pieces may be completely embedded in the wall such that the pole pieces are hermetically sealed from the fluid chamber and the source of mechanical power. The pole pieces may be embedded in the wall such that the pole pieces are hermetically sealed from the fluid chamber but not sealed from the source of mechanical power. The pole pieces may be embedded in the wall such that the pole pieces are hermetically sealed from the source of mechanical power but not sealed from the fluid chamber.

The present invention further provides a geared magnetic drive system comprising a high speed rotor including a first set of magnets, and a low speed rotor including a second set of magnets, wherein the first set of magnets includes a lower number of magnetic poles than the second set, and a plurality of pole pieces located between the rotors and arranged to modulate the magnetic field generated by at least some of the magnets such that rotation of one of the rotors causes rotation of the other, wherein the high speed rotor is located radially outside the low speed drive rotor.

Preferred embodiments of the present invention will now be described by way of example only with reference to the accompanying drawings.

### BRIEF DESCRIPTION OF THE DRAWINGS

FIG. 1 is a schematic section through a rotary magnetic gearing system used in the present invention;

FIG. 2 is a graph illustrating magnetic spatial harmonics associated with the assembly of FIG. 1;

FIG. 3 is a longitudinal section through a pump according to an embodiment of the invention;

FIG. 4 is a longitudinal section through a pump according to a second embodiment of the invention;

FIG. 5 is a longitudinal section through a pump according to a third embodiment of the invention

FIG. 6 is a section through a linear drive system according to a further embodiment of the invention;

FIG. 7 is a section through a flywheel according to a further embodiment of the invention; and

FIG. 8 is a section through a flywheel according to a further embodiment of the invention.

### DESCRIPTION OF THE PREFERRED EMBODIMENTS

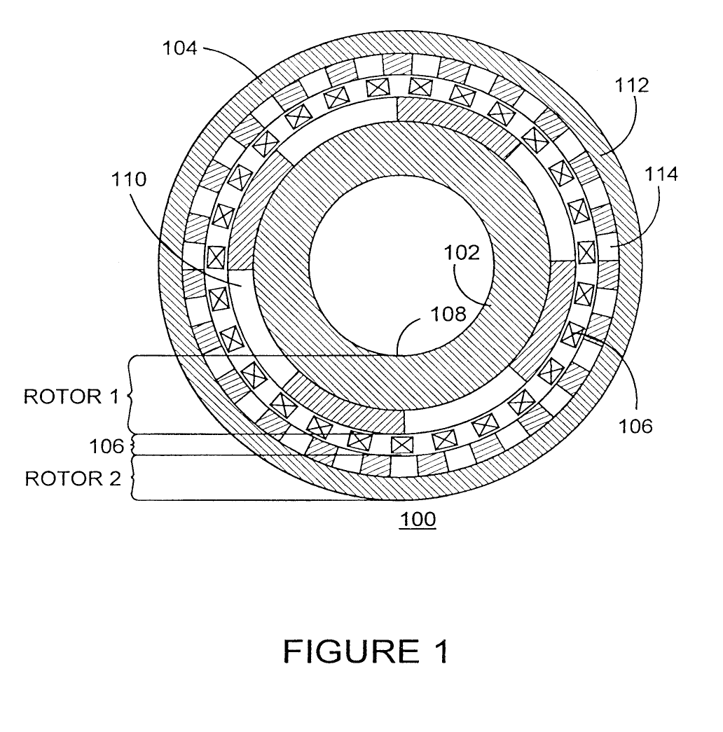

Referring to FIG. 1, a rotary magnetic gear 100 comprises a first or inner rotor 102, a second or outer rotor 104 having a common axis of rotation with the first rotor 102, and a number of pole pieces 106 of ferromagnetic material. The first rotor 102 comprises a support 108 carrying a first set of permanent magnets 110, arranged to produce a spatially varying magnetic field with a number of magnetic poles. In this embodiment, the first rotor 102 comprises eight permanent magnets, or four pole-pairs, arranged to produce a spatially varying magnetic field. The second rotor 104 comprises a support 112 carrying a second set of permanent magnets 114, arranged to produce a spatially varying magnetic field with a different number of poles than is produced by the first set of magnets 110. The second rotor 104 comprises 46 permanent magnets or 23 pole-pairs arranged to produce a spatially varying field. The first and second sets of permanent magnets include different numbers of magnets providing different numbers of magnetic poles. Accordingly, without any modulation of the magnetic fields they produce, there would be little or no useful magnetic coupling or interaction between the permanent magnets 112 and 114 such that rotation of one rotor would not cause rotation of the other rotor.

The ferromagnetic pole pieces 106 are used to control the way in which the fields of the permanent magnets 110 and 114 interact. The pole pieces 106 modulate the magnetic fields of the permanent magnets 110 and 114 so that they interact to the extent that rotation of one rotor will induce rotation of the other rotor in a geared manner. The number of pole pieces is chosen to be equal to the sum of the number of pole-pairs of the two sets of permanent magnets. Rotation of the first rotor 102 at a speed ω₁ will induce rotation of the second rotor 104 at a speed ω_{2 where} ω₁>ω₂. The ratio between the speeds of rotation ω₁ and ω₂, i.e. the gearing ratio of the coupling, is equal to the ratio between the angular spacing of the magnets on the first and second rotors, and therefore in this case also equal to the ratio between the numbers of magnets 110 and 114 on the first and second rotors 102, 104. The gear can operate in reverse, so that rotation of the second rotor 104 causes rotation of the first rotor at a higher speed.

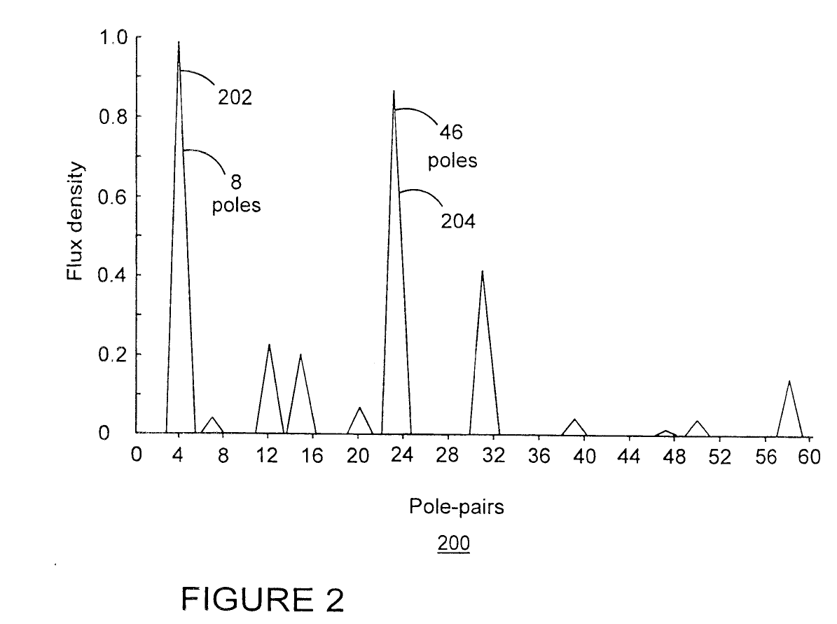

FIG. 2 shows a harmonic spectrum 200 of the spatial distribution of the magnetic flux density of the first set of permanent magnets 110 mounted on the inner rotor 102 of the magnetic gear 100 of FIG. 1, in the airgap adjacent to the second set of permanent magnets 114 mounted on the outer rotor 104. It can be appreciated that the spectrum 200 comprises a first or fundamental component 202 associated with the first set of permanent magnets 110 of the first rotor 102. This is the component of the field of which the spatial frequency corresponds to the spatial frequency of the polarity of the magnets 110 and therefore corresponds to four pole-pairs. The pole pieces 106 modulate the magnetic field of the permanent magnets 110 to provide components of the magnetic field of different spatial frequencies corresponding to different numbers of pole pairs. For the permanent magnets 110, for example, this results in a relatively large asynchronous harmonic 204 having a number of pole pairs which is equal to the difference between the number of pole pieces 106 and the number of pole pairs of the magnets 110 on the inner rotor. This is arranged, by appropriate selection of the number of pole pieces 106, to be the same as the number of pole pairs of the permanent magnets 114 on the outer rotor 104, which enables coupling between the first 102 and the second 104 rotors. Also, with the pole pieces 106 held stationary and the inner rotor 102 rotated, this component of the field rotates at a lower speed than the inner rotor such that movement of one induces movement of the other, in a geared manner.

One skilled in the art understands how to select and design the pole pieces 106, given the first 110 and second 114 permanent magnets, to achieve the necessary magnetic circuit or coupling such that gearing between the first 102 and second 104 rotors results, as can be appreciated from, for example, K. Atallah, D. Howe, “A novel high-performance magnetic gear”, IEEE Transactions on Magnetics, Vol. 37, No. 4, pp. 2844-2846, 2001 and K. Atallah, S. D. Calverley, D. Howe, “Design, analysis and realisation of a high performance magnetic gear”, IEE Proceedings-Electric Power Applications, Vol. 151, pp. 135-143, 2004.

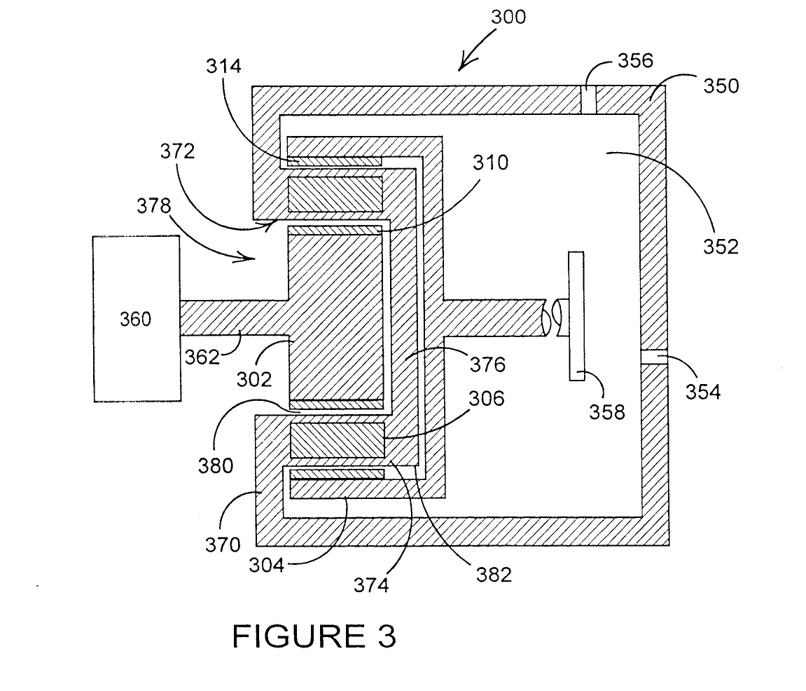

Referring to FIG. 3, a pump 300 comprises a housing 350 defining a fluid chamber 352 having an inlet 354 and an outlet 356. The physical design of the pump is not relevant for the present invention, but in this embodiment the pump has an impellor 358, rotation of which causes fluid to flow from the inlet 354 to the outlet 356. The impellor 358 is driven by a drive system 360 through a magnetic gear which corresponds to that of FIG. 1, with corresponding parts indicated by the same reference numerals increased by 200. The magnetic gear includes an input rotor 302, which is driven by the drive system 360 via a drive shaft 362, and an output rotor 304 which is directly mechanically coupled to the impellor 358.

One wall 370 of the housing 350, which forms one wall of the fluid chamber 352, includes an inwardly projecting portion 372 including a cylindrical portion 374 and an inner end wall 376. The cylindrical portion 374 therefore surrounds an outward facing recess 378, in which the input rotor 302 is located. The output rotor 304 extends around the cylindrical portion, being radially outside it, but within the fluid chamber 352. The pole pieces 306 of the drive system are embedded within the cylindrical wall portion 374, which extends between the input and output rotors 302, 304. Therefore the pole pieces 306 are below both the inner and outer surfaces 380, 382 of the cylindrical wall portion 374, being completely enclosed within the material of the cylindrical wall portion 374. This part of the housing is moulded, with the pole pieces being moulded into the wall. This means that the outer surface 382 of the cylindrical wall portion 374 is smooth. As the permanent magnets 314, which are on the radially inner side of the output rotor 304, are only spaced from the cylindrical wall portion 374 by a small distance, it is advantageous to have the surface of the cylindrical wall portion 374 smooth as this reduces losses due to turbulence in the fluid in the gap between the output rotor 304 and the cylindrical wall portion 374. The same is true for the radially inner surface 380 which needs to be smooth to reduce losses from air turbulence around the high speed rotor 302. In other embodiments the pole pieces are attached to the cylindrical wall in other ways. For example they may be mounted on the surface of the cylindrical wall or may be flush with either or both of the inner and outer surfaces 380, 382.

It will be appreciated that in operation the magnetic gear provides a geared drive between the drive system 360 and the pump without the need for any mechanical coupling between the inside and the outside of the fluid chamber 352. The drive to the pump is provided purely via the coupling of the magnetic fields of the rotors through the wall 370 of the fluid chamber. The embedding of the pole pieces 306 within the wall 370 allows the close proximity of the permanent magnets 310, 314 of the rotors to the pole pieces 306 to be maintained, thereby maintaining an efficient coupling.

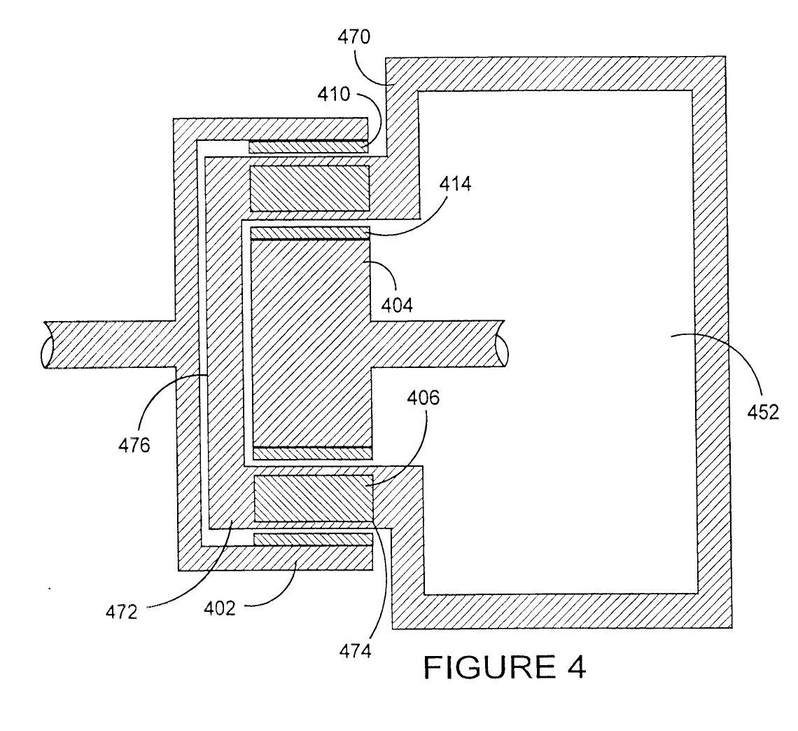

Referring to FIG. 4, a second embodiment operates in a similar manner to the first embodiment with corresponding parts being indicated by corresponding reference numerals increased by 100. In this embodiment, the end wall 470 includes an outwardly projecting portion 472 including a cylindrical portion 474 and an outer end wall 476. The input rotor 402 of the geared drive coupling is therefore arranged radially outside the cylindrical wall portion 474 and the output rotor 404 is arranged radially inside the cylindrical wall portion, and therefore also radially inside the input rotor 402. The input rotor 402 again has fewer permanent magnets 410 than the output rotor 404, and its magnets are at a greater spacing, in this case the input rotor has four pole pairs, the output rotor permanent magnets 414 include 23 pole pairs, and there are 27 pole pieces 406 embedded in the cylindrical wall section 474. It will be appreciated that in this arrangement, operation is similar to the first embodiment, and the output rotor 404 will rotate more slowly than the input rotor 402, the gear ratio being determined by the ratio of the numbers of permanent magnets on the rotors 402, 404 in the same way as in the first embodiment.

This embodiment has the advantage that the smaller diameter rotor 404 is the output rotor, which is the rotor inside the fluid chamber. This results in a simpler construction of the housing 450, but more significantly, much less drag on the output rotor, which reduces the losses within the drive coupling and makes it more efficient. It will be appreciated that this arrangement, with the inner rotor being the low speed rotor and the outer rotor being the high speed rotor, which is not achievable with a mechanical drive coupling, can be used in other applications apart from pumps.

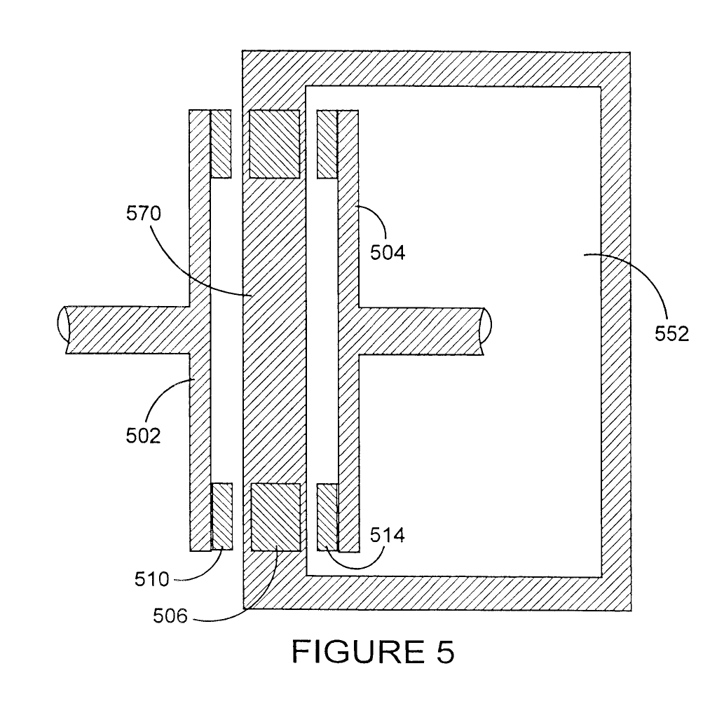

Referring to FIG. 5 in the third embodiment of the invention, the drive coupling is axially orientated. The input rotor 502 has a circular array of magnets 510 with their poles at their axial ends, again with alternating polarity around the array. The end wall 570 of the fluid chamber 552 between the rotors is flat, and has a circular array of pole pieces 506 embedded within it. The low speed, output rotor 504 has a circular array of magnets 514, arranged on the opposite side of the end wall 570 to the magnets 510 on the input rotor 502, again with their poles at their axial ends and with alternating polarity around the rotor 504. It will be appreciated that this embodiment will operate in substantially the same way as the first and second embodiments, with the gearing ratio determined by the ratio of the numbers of magnets 510, 514 on the input and output rotors 502, 504, and the number of pole pieces being selected as required.

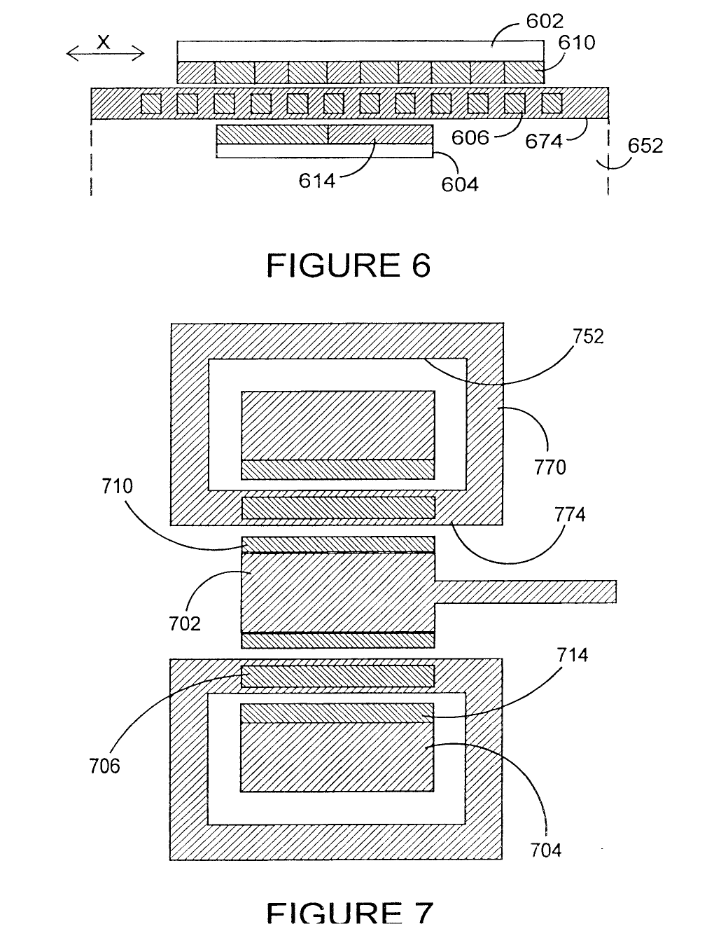

Referring to FIG. 6, in a further embodiment of the invention, the drive system is linear, and the magnetic gear comprises an input member 602 or translator arranged to move linearly in either direction along an axis X, an output member 604 or translator also arranged to move linearly in either direction along the same axis, and a wall 674 which encloses a fluid chamber 652 in which the output member 604 is located. In this embodiment the input member 602, output member 604 and wall 674 are annular, with FIG. 6 showing a section through one side of the gear system. In other embodiments the input and output members and the wall between them are flat and planar.

The gear system of FIG. 6 is the linear equivalent of the gear system of FIG. 3, with movement of the input member 602 producing movement of the output member 604 at a lower speed, the ratio of the speeds depending on the linear spacing of the two sets of magnets 610, 614 and the pole pieces 606.

The linear gear system of FIG. 6 can be used in a number of applications, for example for controlling robots inside hermetically sealed enclosures.

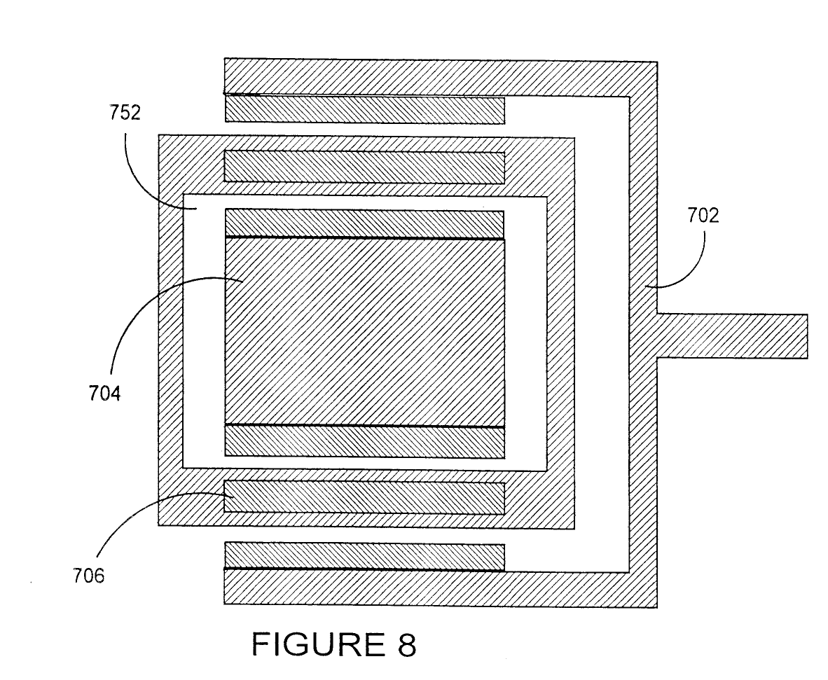

Referring to FIG. 7, in a further embodiment of the invention the magnetic gearing system is used to drive a flywheel which forms one of the rotary members 704. The other of the rotary members 702 is used to input energy to the flywheel and also to extract energy from it. The flywheel is supported on a very low friction bearing system, and the fluid chamber is annular so that the flywheel 704 is entirely enclosed within it. The fluid chamber 752 is in this case a vacuum chamber, being evacuated to a very low pressure so as to minimise the energy loss from the flywheel. The chamber 752 is therefore sealed so as to be airtight. The gearing is arranged such that the input member 702 is the low speed rotor and the flywheel 704 is the high speed rotor. Suitable gearing ratios would be of the order of 10 to 1 up to 30 to 1.

Referring to FIG. 8, where like parts to that described in FIG. 7 are provided with identical reference numerals, the rotary member 702 is an outer rotor and arranged as the low speed, high pole piece number rotor. In this way the magnetic gearing system is inverted compared to that described in relation to FIG. 7.

While in each of the embodiments described above, each of the permanent magnets is a simple dipole with one north and one south pole, it will be appreciated that, while the positioning of the magnetic poles is critical to the operation of each embodiment, any arrangement of pole pairs can be provided by a number of different arrangements of magnets, i.e. blocks of magnetized material. For example more than one pole pair can be provided by a single magnetized block.

1. A magnetically geared system comprising a housing defining a sealed chamber, a driving member including a first set of magnets, and a driven member comprising a second set of magnets, one of the members being located inside the chamber, wherein the first and second sets of magnets are arranged to produce different numbers of magnetic poles, and the housing includes a wall extending between the members and supporting a plurality of pole pieces which are arranged to modulate the magnetic field acting between the magnets.

2. A system according to claim 1 wherein the driven member is located within the chamber.

3. A system according to claim 1 or claim 2 wherein the spacing of the magnetic poles of the first set of magnets is greater than the spacing of the magnetic poles of the second set such that the driven member is driven at a slower speed than the driving member.

4. A system according to claim 1 or claim 2 wherein the spacing of the magnetic poles of the first set of magnets is less than the spacing of the magnetic poles of the second set such that the driven member is driven at a higher speed than the driving member.

5. A system according to any foregoing claim wherein the members are rotors.

6. A system according to claim 5 wherein the wall is cylindrical in form and one of the rotors is arranged radially inside the wall and the other of the rotors is arranged radially outside the wall.

7. A system according to claim 5, wherein the wall is flat in form and the rotors are arranged in an axial arrangement on either side of the wall.

8. A system according to claim 5 or claim 6 wherein one of the rotors forms a flywheel.

9. A system according to claim 8 wherein the flywheel is arranged to be driven by the other member to input energy to the flywheel, and to drive the other member to extract energy from the flywheel.

10. A system according to any of claims 1 to 4 wherein the drive member is arranged to drive the driven member linearly.

11. A system according to any foregoing claim wherein the pole pieces are embedded in the wall.

12. A system according to any foregoing claim wherein the pole pieces are located below the surface of the wall facing the chamber such that the pole-pieces are sealed from the chamber.

13. A system according to any foregoing claim wherein the pole pieces are located below the surface of the wall facing away from the chamber.

14. A geared drive system comprising a high speed rotor including a first set of magnets, and a low speed rotor including a second set of magnets, wherein the first set of magnets includes a lower number of magnetic poles than the second set and a plurality of pole pieces located between the rotors and arranged to modulate the magnetic field generated by at least some of the magnets such that rotation of one of the rotors causes rotation of the other, wherein the high speed rotor is located radially outside the low speed drive rotor.

15. A drive system according to claim 14 wherein the high speed rotor is an input rotor and the low speed rotor is an output rotor.

16. A system substantially as described herein with reference to any one or more of the accompanying drawings.
